(19) United States
(12) Patent Application Publication
(10) Pub. No.: US 2002/0157483 A1
(43) Pub. Date: Oct. 31, 2002

(54) Sampling apparatus for adsorbing volatile organic compound in semiconductor operating environment

(76) Inventors: Jiunn-Guang Lo, Hsinchu (TW); Min-Nan Lin, Ilan (TW)

Correspondence Address: Mathews. Collins, Shepherd & Gould, P.A., Suite 306, 100 Thanet Circle, Princeton, NJ, 08540-3674, US

(21) Appl. No.: 09/883,515

(22) Filed: Jun. 18, 2001

(30) Foreign Application Priority Data
Feb. 27, 2001 (TW) 090104622

(51) Int. Cl. G01N 1/04

(52) U.S. Cl. 73/864.71

(57) ABSTRACT

A sampling apparatus applied in a semiconductor operating environment for collecting a volatile organic compound. The sampling apparatus includes an automatic sampling device, and a multi-sorbent trap connected to the automatic sampling device sample for adsorbing the volatile organic compound at room temperature, wherein the volatile organic compound includes a polar and a non-polar compounds.

### FIELD OF THE INVENTION

The present invention relates to a sampling apparatus applied in a semiconductor operating environment, and more particularly to a sampling apparatus using a multi-sorbent trap for adsorbing a volatile organic compound in a semiconductor operating environment.

### BACKGROUND OF THE INVENTION

Currently, the photoelectric and semiconductor industries have become star industries and promoted the quick economy development. However, it is necessary to use a lot of toxic gases and organic solvents in the semiconductor process. Those hazardous materials may be dissipated into air due to carelessness of operators, improper maintainment of processing equipment, or special reaction, which causes environment pollution and is harmful to operators' health.

Among semiconductor operating environment, the customarily used organic solvents include dichloromethane, isopropyl alcohol, toluene, 1,1,1-trichloroethylene and acetone, etc. Acetone and isopropyl alcohol are often used as cleaning and washing solvents or as a raw material, while toluene is a component of some photoresists in photolithography process. Those solvents will be dissipated into air by the dissipating system to cause environment pollution.

Referring to the volatile organic compound, the typical sampling method includes stainless steel bottle sampling method, sampling bag method, liquid adsorbing method, and solid absorbing method. Generally, the solid adsorbing method is used because the adsorbent has high selectivity to avoid the interference of other substrates and concentration effect to enhance the sensitivity, and the sampling tube is convenient to be carried and not costly. However, the environmental temperature and humidity, sample concentration, sampling flow rate will affect the adsorptive capacity of adsorbent when using the solid adsorbing method. In addition, the way and the period for storage will also affect the sample stability in the absorbent.

At present, for determining the volatile organic compound in the semiconductor plant, charcoal or silica gel is used as an absorbent, the solvent is used for desorption, and the sample is finally analyzed by gas chromatograph. The solvents including carbon disulfide, toluene, methanol and benzene are toxic materials, so it is easy to cause the secondary pollution which is harmful during analysis. In addition, the solvent also possibly causes the chromatograph interference of the volatile organic compound.

Generally, for determination of hydrocarbon, Tenax-TA is a preferred adsorbent which is used especially for sampling a low concentration of volatile organic compound or in high humidity environment. However, Tenax-TA cannot quantitatively adsorb the hydrocarbon with low boiling point, for example the hydrocarbon having the carbon number less than 6. Hence, for adsorbing the hydrocarbons with lower boiling points and the compounds with larger range of boiling points, a multi-sorbent trap containing multiple adsorbents is widely used. However, currently the multi-sorbent trap cannot simultaneously adsorb the polar and non-polar organic gases in the semiconductor operating environment for the follow-up determination. In addition, the typical adsorption has to be proceeded at low temperature.

Therefore, the purpose of the present invention is to develop a sampling apparatus to deal with the above situations encountered in the prior art.

### SUMMARY OF THE INVENTION

It is therefore an object of the present invention to propose a sampling apparatus for adsorbing a polar and non-polar organic compounds simultaneously.

It is therefore another object of the present invention to propose a sampling apparatus for collecting a volatile organic compound at room temperature.

It is therefore an additional object of the present invention to propose a sampling apparatus for conveniently proceeding qualitative and quantitative analysis of the volatile organic compound in the semiconductor operating environment at the same time to reduce labor- and time-consumptions.

It is therefore an additional object of the present invention to propose a sampling apparatus for more conveniently and flexibly applied in the semiconductor operating environment.

According to the present invention, there is proposed a sampling apparatus applied in a semiconductor operating environment for collecting a volatile organic compound. The sampling apparatus includes an automatic sampling device, and a multi-sorbent trap connected to the automatic sampling device sample for adsorbing the volatile organic compound at room temperature, wherein the volatile organic compound includes a polar and a non-polar compounds.

Certainly, the volatile organic compound can be acetone, isopropyl alcohol (IPA), benzene, trichloroethylene, toluene, butyl acetate, m,p-xylene, o-xylene, cyclopentanone, 2-heptanone or the any mixture thereof.

Preferably, the multi-sorbent trap is connected to a freezing concentration thermal desorption apparatus for desorbing the volatile organic compound. The freezing concentration thermal desorption apparatus is preferably connected to a gas chromatograph and a mass spectrophotometer for proceeding qualitative and quantitative analysis of the volatile organic compound.

Preferably, the volatile organic compound has a minimum detecting concentration of ppbv.

Preferably, the multi-sorbent trap has an adsorbent including a graphitized carbon black and a carbon molecular sieve, wherein the graphitized carbon black has a specific area of 10˜100 cm²/g and the carbon molecular sieve has a specific area of 800˜850 cm²/g.

Preferably, the multi-sorbent trap is a glass tube.

Preferably, the automatic sampling device is a continuously automatic sampling device, wherein the continuously automatic sampling device is connected to 24 the multi-sorbent traps.

According to the present invention, there is proposed a sampling apparatus applied in a semiconductor operating environment for collecting a volatile organic compound. The sampling apparatus includes an automatic sampling device connected to a multi-sorbent trap for adsorbing the volatile organic compound at room temperature, wherein the volatile organic compound includes a polar and a non-polar compounds, a freezing concentration thermal desorption apparatus connected to the multi-sorbent trap for desorbing the volatile organic compound, and a gas chromatograph and a mass spectrophotometer connected to the freezing concentration thermal desorption apparatus for proceeding qualitative and quantitative analysis of the volatile organic compound.

Preferably, the gas chromatograph is connected to the mass spectrophotometer in series.

The present invention may best be understood through the following description with reference to the accompanying drawings, in which:

### BRIEF DESCRIPTION OF THE DRAWINGS

FIG. 1 is a diagram illustrating an adsorbing and a desorbing directions of a multi-sorbent trap according to a preferred embodiment of the present invention;

FIG. 2 is the plot illustrating the relationship between the peak area of different volatile organic compounds and the desorption temperature of the multi-sorbent trap according to a preferred embodiment of the present invention;

FIG. 3 is the plot illustrating the relationship between the peak area of different volatile organic compounds and the desorption time of the multi-sorbent trap according to a preferred embodiment of the present invention;

FIG. 4 is a standard chromatogram illustrating nine volatile organic compounds in semiconductor operation environment according to the present invention; and

FIG. 5 is a chromatogram illustrating the volatile organic compounds practically collected and analyzed in a semiconductor plant according to the present invention.

### DETAILED DESCRIPTION OF THE PREFERRED EMBODIMENTS

An automatic sampling device according to the present invention employs a multi-sorbent trap to adsorb a volatile organic compound in semiconductor environment at room temperature for a long period. The principle of the automatic sample device is implemented by using a negative pressure inside a box caused by sucking via a fan. The air enters into the box and then is guided to the multi-sorbent trap by an active pump. Through presetting a holding time and a flow rate, a rotating plate of the automatic sample device will rotate to next multi-sorbent trap at preset time. The automatic sampling device can be connected to 24 multi-sorbent traps at most. The range of holding time is from 0.1 second to 24 hours.

As shown in Table 1, nine polar and non-polar volatile organic compounds are often detected in semiconductor operation environment. The volatile organic compound includes acetone, isopropyl alcohol (IPA), toluene, benzene, trichloroethylene, butyl acetate, cyclopentanone, m,p-xylene, o-xylene and 2-hetanone. Table 1 shows the chemical and physical properties of the volatile organic compounds.

TABLE 1
Chemical and physical properties of the volatile organic compound

| | Properties | | | | | |
|---|---|---|---|---|---|---|
| | | MW | | | Vapor | |
| | Chemical | (g/ | Bp. | Mp. | pressure | PEL* |
| VOCs | formula | mole) | (° C.) | (° C.) | (mm-Hg) | ppm |
| Acetone | (CH₃)₂CH₃ | 58.08 | 56.2 | −95.4 | 266 | 750 |
| IPA | C₃H₈O | 60.09 | 82.4 | −86 | 33 | 400 |
| Toluene | C₆H₅CH₃ | 92.14 | 110.6 | −95 | 28.4 | 100 |
| Benzene | C₆H₆ | 78 | 80 | 5.5 | 75 | 5 |
| Trichloro- | Cl₂═CHCl | 131.5 | 86.7 | −73 | 57.8 | 50 |
| ethylene | | | | | | |
| Butyl acetate | C₆H₁₂O₂ | 116 | 126.3 | −77 | 15 | 150 |
| Cyclopenta- | C₅H₈O | 84.1 | 131 | −58 | | |
| none | | | | | | |
| 2-Heptanone | C₇H₁₄O | 114.2 | 151.5 | −35 | 1.6 | 50 |
| m,p-Xylene | C₈H₁₀ | 106.2 | 137-140 | | 6-6.5 | 100 |

*PEL = Permissible Exposure Limits

According to the volatile organic compounds occurred in the high technology industry, a series of adsorbents are evaluated as shown in Table 2. As shown in Table 2, the combination of Carbopack B, Carbopack C and Carbosieve SIll is adapted to adsorb most of the volatile organic compounds, wherein Carbopack B and Carbopack C are graphitized carbon blacks and Carbosieve Sill is a carbon molecular sieve. According to the properties of Carbopack B, Carbopack C and Carbosieve SIII as shown in Table 3, Carbopack B and Carbopack C have a specific area of 10, 100, 820 m²/g, respectively.

TABLE 2
Evaluation of the adsorbent selection for adsorbing the volatile organic
compound

| | | | | | | | | C |
|---|---|---|---|---|---|---|---|---|
| | CP.B | CT1 | CT2 | CT3 | C.S106 | T.N | CSIII | 1000 |
| IPA | ● | ● | ● | ● | ● | | | |
| Acetone | | | ● | ● | ● | | ● | ● |
| 2-Butanone | ● | ● | ● | ● | ● | ● | | |
| Dichloro- | | | | ● | ● | | ● | |
| methane | | | | | | | | |
| PGMEA | | | | | | | | |
| Cyclopenta- | ● | ● | ● | ● | ● | ● | | |
| none | | | | | | | | |
| 2-Heptanone | | | | | | | | |
| Trichloro- | ● | ● | ● | ● | ● | ● | | |
| ethylene | | | | | | | | |
| Benzene | ● | ● | ● | ● | ● | ● | | |
| Toluene | ● | ● | ● | ● | ● | ● | | |
| Xylene | ● | ● | ● | ● | ● | ● | | |
| Butyl acetate | ● | ● | ● | ● | ● | ● | | |

Footnote:
1. represents the adsorbent adapted to adsorb the volatile organic compound
2. CP.B = Carbopack B
CT1 = Tenax GR + Carbopack B
CT2 = Carbopack B + Carbosieve S III or Carboxen 1000
CT3 = Carbopack B + Carbopack C + Carbosieve S III
C.S106 = Chromosorb 106
T.N = Tenax
CSIII = Carbosieve SIII

TABLE 3
Properties of Carbopack B, Carbopack C and Carbosieve SIII

| | | | Specific area |
|---|---|---|---|
| Type | Max. Temp. (° C.) | Adsorption Range | (m²/g) |
| Carbopack C | >400 | C₈-C₂₀ | 10 |
| Carbopack B | >400 | C₅-C₁₄ | 100 |
| Carbosieve S III | 400 | C₃-C₄ | 820 |

Referring to the preparation of the multi-sorbent trap, a glass tube having an outside diameter of ¼ inch and an inside diameter of 4 mm is immersed into deionized water, treated by ultrasonic for 3 hours, and then put into an oven at 300° C. for 12 hours. After above treatments, the glass tube is filled with 0.2 g of Carbopack C, 0.2 g of Carbopack B and 0.2 g of Carbosieve Sill in order, wherein three adsorbents are separated by a glass wool. Sequentially, the multi-sorbent trap is placed in a nine-tube conditioner at 300° C. to heat for 12 hours and be passed through a nitrogen gas with a flow rate of 50 mL/min for removing the impurity on the adsorbent and the glass wool. After conditioning, one multi-sorbent trap is used to do blank test for assuring the cleanness.

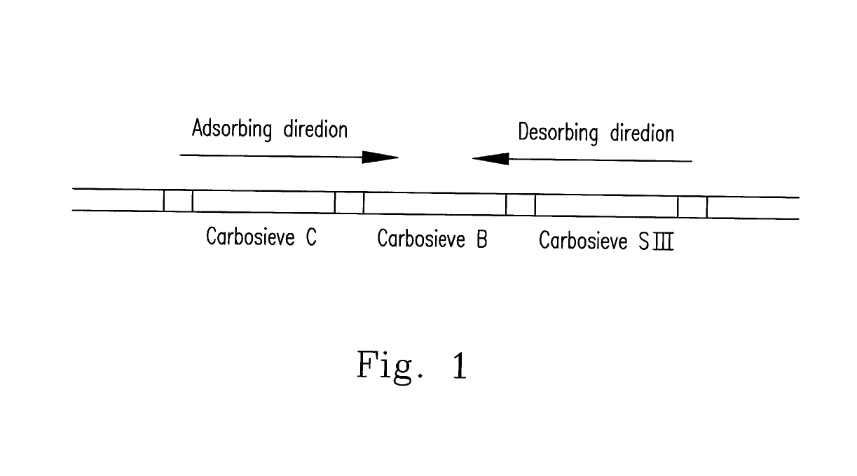

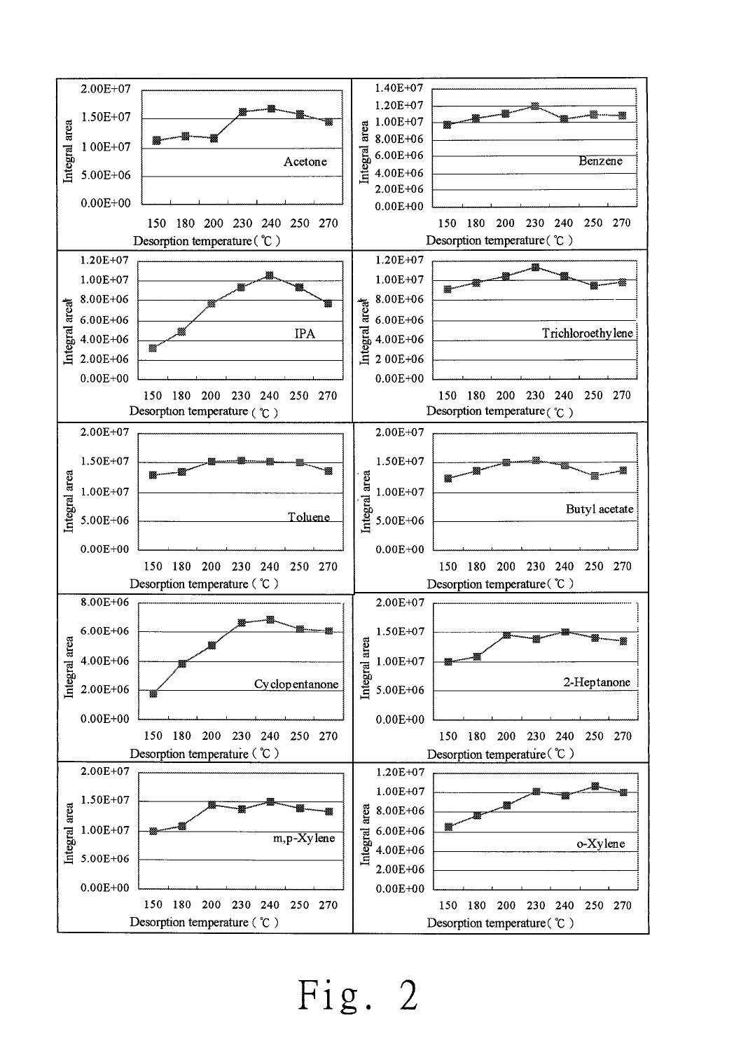

The multi-sorbent trap is connected to the automatic sampling device for adsorbing the volatile organic compound in the semiconductor operating environment. Sequentially, the multi-sorbent trap is taken off from the automatic sampling device and connected to a freezing concentration thermal desorption apparatus for desorbing the volatile organic compound. The adsorbing and desorbing directions of the multi-sorbent trap are shown in FIG. 1. The freezing concentration thermal desorption is performed at the condition that the cooling temperature is −150° C., the desorption flow rate is 30 mL Helium /min, the cooling desorption temperature is 200° C. and the cooling desorption time is 5 minutes. The recovery rate of the volatile organic compound is increased with increasing a desportion temperature of the multi-sorbent trap. As shown in Table 4 and FIG. 2, when the desorption temperature of the multi-sorbent trap is 230° C. or 240° C., all volatile organic compounds have the highest recovery rates. However, when the desorption temperature of the multi-sorbent trap is over 240° C., the recovery rate decreases due to the decomposition of the volatile organic compound.

TABLE 4
Recovery rate of volatile organic compound at different desorption
temperatures of the multi-sorbent trap

| Desorp. Temp. | | | | | | | |
|---|---|---|---|---|---|---|---|
| (° C.) | 150 | 180 | 200 | 230 | 240 | 250 | 270 |
| Acetone | 69.61% | 73.86% | 71.52% | 100.00% | 104.27% | 97.31% | 90.03% |
| IPA | 34.50% | 51.82% | 82.29% | 100.00% | 111.87% | 99.26% | 82.22% |
| Benzene | 81.47% | 87.85% | 92.13% | 100.00% | 87.09% | 91.06% | 90.09% |
| Trichloro- | 80.78% | 86.35% | 92.13% | 100.00% | 92.32% | 83.23% | 86.46% |
| ethylene | | | | | | | |
| Toluene | 83.69% | 86.91% | 99.47% | 100.00% | 98.76% | 97.38% | 88.09% |
| Butyl acetate | 79.20% | 87.12% | 97.73% | 100.00% | 93.44% | 82.25% | 88.24% |
| Cyclopenta- | 26.51% | 57.96% | 76.60% | 100.00% | 103.97% | 93.63% | 91.49% |
| none | | | | | | | |
| M,p-Xylene | 61.26% | 70.66% | 87.87% | 100.00% | 95.39% | 95.21% | 90.81% |
| 2-Heptanone | 71.65% | 78.89% | 104.86% | 100.00% | 108.75% | 100.72% | 97.02% |
| o-Xylene | 64.00% | 75.67% | 85.89% | 100.00% | 95.79% | 105.89% | 98.83% |

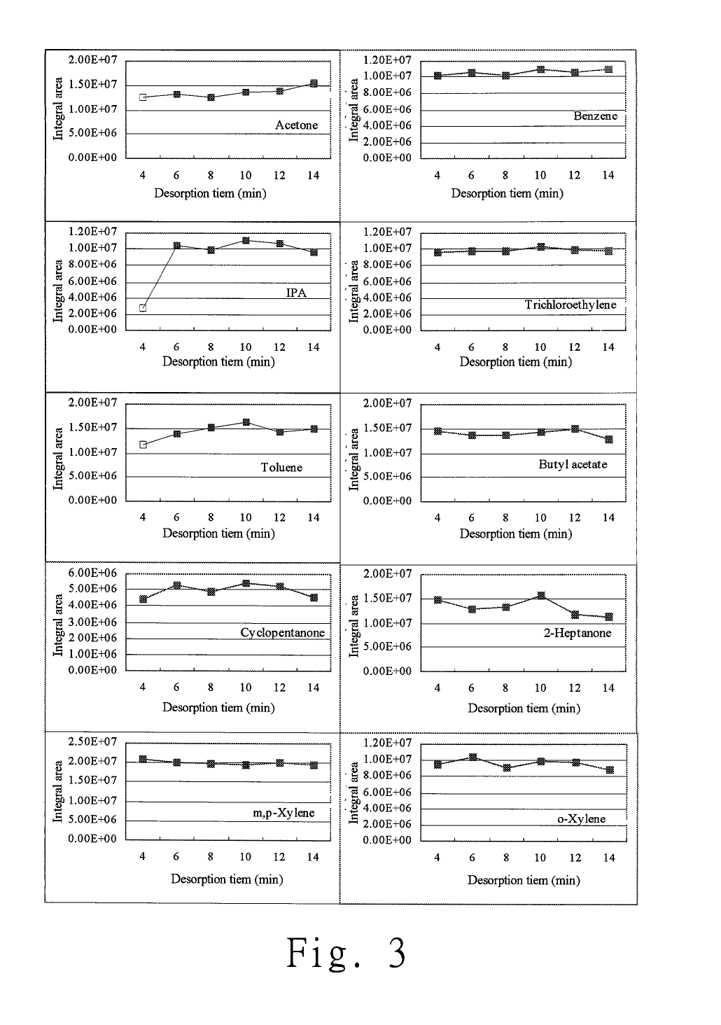

Sequentially, when the desorption temperature of the multi-sorbent trap is 230° C. with the desorption flow rate of 30 mL/min, the cooling temperature of −150° C., the cooling desorption temperature of 200° C., and the cooling desorption time of 5 minutes, the recovery rate of the volatile organic compound is affected by the desorption time of the multi-sorbent trap as shown in Table 5 and FIG. 3. According to the results, when the desorption time of the multi-sorbent trap is 10 minutes, most of the volatile organic compounds have the highest recovery rates.

TABLE 5
Recovery rate of volatile organic compound at 230° C. for different
desorption times of the multi-sorbent trap

| Desorp. Temp. | | | | | | |
|---|---|---|---|---|---|---|
| (° C.) | 4 | 6 | 8 | 10 | 12 | 14 |
| Acetone | 90.85% | 95.51% | 91.54% | 100.00% | 101.62% | 111.55% |
| IPA | 25.04% | 94.17% | 90.08% | 100.00% | 97.07% | 87.50% |
| Benzene | 93.26% | 96.55% | 92.86% | 100.00% | 96.38% | 100.51% |
| Trichloro- | 93.37% | 94.12% | 94.88% | 100.00% | 96.41% | 94.50% |
| ethylene | | | | | | |
| Toluene | 70.80% | 84.17% | 92.74% | 100.00% | 87.69% | 91.80% |
| Butyl acetate | 101.79% | 96.19% | 95.71% | 100.00% | 105.68% | 89.87% |
| Cyclopenta- | 81.42% | 96.91% | 89.58% | 100.00% | 96.23% | 83.95% |
| none | | | | | | |
| M,p-Xylene | 105.86% | 101.95% | 100.31% | 100.00% | 101.65% | 99.31% |
| 2-Heptanone | 94.38% | 81.40% | 84.08% | 100.00% | 75.54% | 72.38% |
| o-Xylene | 95.92% | 104.89% | 92.40% | 100.00% | 99.27% | 89.31% |

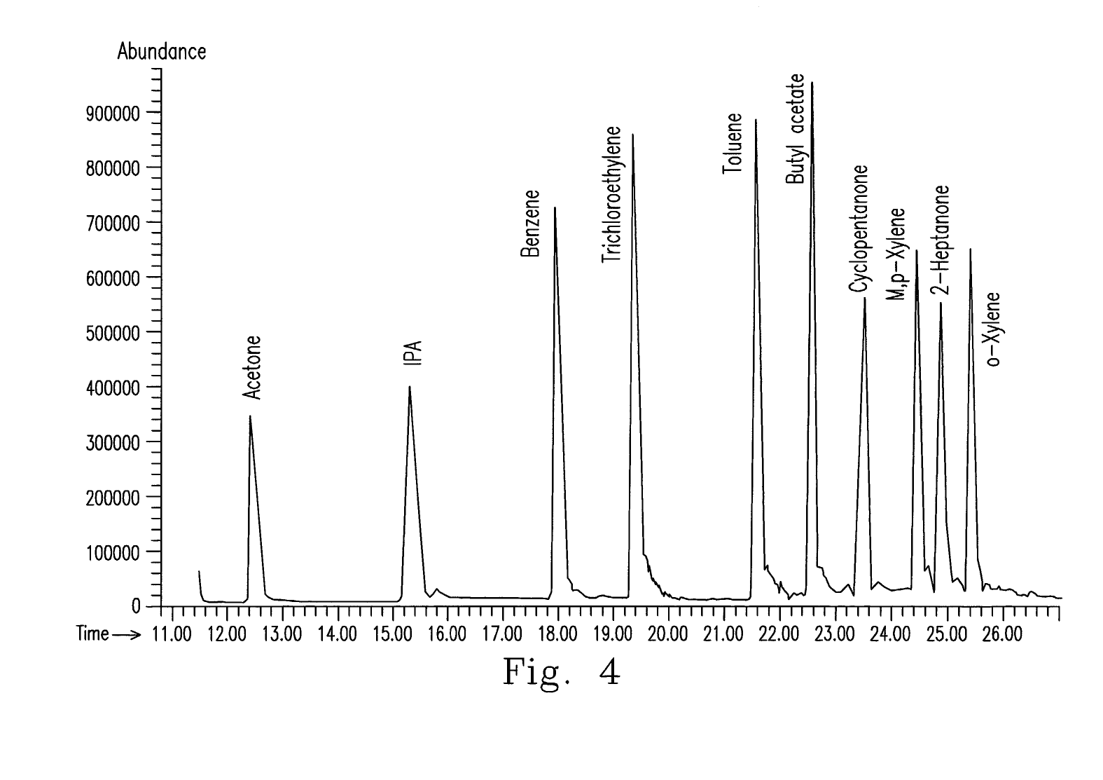

After desorption, the volatile organic compound is introduced into a gas chromatograph and a mass spectrophotometer for proceeding qualitative and quantitative analysis. The gas chromatograph includes a capillary column for separating the volatile organic compounds. According to a preferred embodiment of the present invention, a DB-Wax capillary column having a size of 0.32 mm×60 m and a film thickness of 0.5 μm is used for separating the volatile organic compound. When the inlet pressure of carrying gas is 0.375 kg/cm², the capillary column is held at its initial temperature of 35° C. for 7 minutes, increased to 91° C. at a rate of 7° C./min, then increased to 154° C. at a rate of 9° C./min and held for 5 minutes, and quickly increased to 194° C. at a rate of 20° C./min and held for 5 minutes finally. According to the above separation condition, the volatile organic compound can be efficiently separated and the standard chromatogram is shown in FIG. 4.

In addition, the minimum detecting concentration according to the present invention for the volatile organic compound is shown in Table 6. When the sample volume is 1 liter, the minimum detecting concentrations of the volatile organic compounds are between 0.31 to 0.89 ppb.

TABLE 6
Minimum detecting limitation (MDL) of volatile organic compound
according to the present invention

| | MDL (ng) | MDL (ppb*) | RSD |
|---|---|---|---|
| Acetone | 0.99 | 0.42 | 3.50% |
| IPA | 1.39 | 0.56 | 5.26% |
| Benzene | 2.83 | 0.89 | 6.44% |
| Trichloroethylene | 2.90 | 0.54 | 4.51% |
| Toluene | 1.65 | 0.44 | 5.39% |
| Butyl acetate | 1.45 | 0.31 | 3.72% |
| Cyclopentanone | 2.53 | 0.73 | 5.63% |
| m,p-Xylene | 2.61 | 0.60 | 5.81% |
| 2-Heptanone | 3.06 | 0.65 | 6.10% |
| o-Xylene | 3.80 | 0.87 | 6.70% |

*sampling volume is 1 liter.

Referring the recovery rate determination, a known amount sample of the volatile organic compound is added to the multi-sorbent trap and is proceeded the above treatments and analysis. The data is triplicate and the integral area of the peak is represented as As. Similarly, the same sample is added to a glass tube without adsorbents and glass wools and is directly proceeded analysis. The data is also triplicate and the integral area of the peak is represented as Ao. Thus, the recovery rate is designated as As/Ao×100%. Table 7 shows the average recovery rate of the volatile organic compounds. The average recovery rate is 90.41˜100.19%, wherein the average recovery rates of benzene, trichloroethylene, butyl acetate and 2-heptanone are above 95%.

TABLE 7
Recovery rate determination of volatile organic compound

| | | | | Average of |
|---|---|---|---|---|
| | Conc. (ng) | Conc. (ng) | Conc. (ng) | recovery rate (%) |
| Acetone | 47.4 | 711 | 1422 | 93.87 |
| Recovery (%)* | 97.31 | 93.36 | 90.93 | |
| IPA | 46.8 | 702 | 1404 | 93.79 |
| Recovery (%)* | 95.00 | 92.97 | 93.40 | |
| Benzene | 26.4 | 396 | 792 | 100.19 |
| Recovery (%)* | 101.25 | 99.58 | 99.75 | |
| Trichloroethylene | 43.8 | 657 | 1314 | 96.81 |
| Recovery (%)* | 98.21 | 96.35 | 95.87 | |
| Toluene | 26.1 | 391.5 | 783 | 92.50 |
| Recovery (%)* | 97.24 | 91.21 | 89.05 | |
| Butyl acetate | 26.1 | 391.5 | 783 | 97.74 |
| Recovery (%)* | 98.65 | 97.27 | 97.29 | |
| Cyclopentanone | 28.5 | 427.5 | 855 | 91.52 |
| Recovery (%)* | 93.78 | 90.65 | 90.14 | |
| m,p-Xylene | 25.8 | 387 | 774 | 94.41 |
| Recovery (%)* | 96.89 | 93.87 | 92.47 | |
| 2-Heptanone | 24.6 | 369 | 738 | 98.93 |
| Recovery (%)* | 99.87 | 99.05 | 97.86 | |
| o-Xylene | 26.4 | 396 | 792 | 94.67 |
| Recovery (%)* | 96.19 | 93.87 | 93.96 | |

*Average value of the triplicate data

In addition, referring to the stability test of the volatile organic compound absorbed in the multi-sorbent trap, a know amount volatile organic compound is added to the multi-sorbent trap, purged with nitrogen, tired at two ends by copper stopper, wrapped by wrap film, put in a sealed container and stored at 3° C. or room temperature. During 28 day storage, the relative recovery rate of the volatile organic compound is shown in Table 8. According to the results, all volatile organic compounds have the better relative recovery rates at 3° C. than those at room temperature. In addition, all volatile organic compounds except for 2-heptanone have above 90% relative recovery rates at 3° C. during 7-day storage.

TABLE 8
The relative recovery rate of volatile organic compound at 3° C. or room
temperature during 28 day storage

| | Added | Storage | Relative recovery rate (%)* | | | | |
|---|---|---|---|---|---|---|---|
| VOCs | amount(ng) | Temp. | 0 day | 7 day | 14 day | 21 day | 28 day |
| Acetone | 118.5 | RT** | 100 | 96.84 | 80.39 | 75.11 | 68.49 |
| | | 3° C. | 100 | 99.16 | 87.31 | 84.87 | 80.04 |
| IPA | 117 | RT** | 100 | 94.13 | 81.24 | 74.85 | 65.46 |
| | | 3° C. | 100 | 97.38 | 89.12 | 85.07 | 77.08 |
| Benzene | 132 | RT** | 100 | 98.56 | 92.57 | 87.25 | 90.48 |
| | | 3° C. | 100 | 102.57 | 104.21 | 93.87 | 96.85 |
| Trichloro- | 219 | RT** | 100 | 95.36 | 84.98 | 89.25 | 80.47 |
| ethylene | | 3° C. | 100 | 99.78 | 103.55 | 96.52 | 94.69 |
| Toluene | 130.5 | RT** | 100 | 96.08 | 90.18 | 88.41 | 87.03 |
| | | 3° C. | 100 | 102.63 | 95.96 | 92.29 | 89.46 |
| Butyl | 130.5 | RT** | 100 | 93.58 | 93.19 | 90.47 | 86.15 |
| acetate | | 3° C. | 100 | 98.99 | 101.47 | 96.49 | 96.04 |
| Cyclopenta- | 142.5 | RT** | 100 | 90.59 | 88.63 | 78.15 | 66.25 |
| none | | 3° C. | 100 | 96.48 | 90.24 | 86.19 | 79.28 |
| m,p-Xylene | 129 | RT** | 100 | 98.69 | 90.15 | 88.68 | 82.14 |
| | | 3° C. | 100 | 98.89 | 94.51 | 96.24 | 90.14 |
| 2-Heptanone | 123 | RT** | 100 | 89.25 | 80.47 | 77.69 | 73.41 |
| | | 3° C. | 100 | 93.54 | 86.24 | 80.99 | 76.54 |
| o-Xylene | 132 | RT** | 100 | 96.26 | 93.18 | 94.85 | 89.29 |
| | | 3° C. | 100 | 106.28 | 99.27 | 93.58 | 94.17 |

*The recovery rate is relative to that of 0 day (average of triplicate data)
**RT = room temperature

The sampling apparatus according to the present invention is applied in a semiconductor plant in Science-Park for collecting the volatile organic compound sample in environment. The sampling spot is a yellow region in the semiconductor plant and the sampling time is from 10:15 am to 10:15 am next day. The sampling interval is 1 hour and the sampling flow rate is between 18.16 mL/min to 19.8 mL/min.

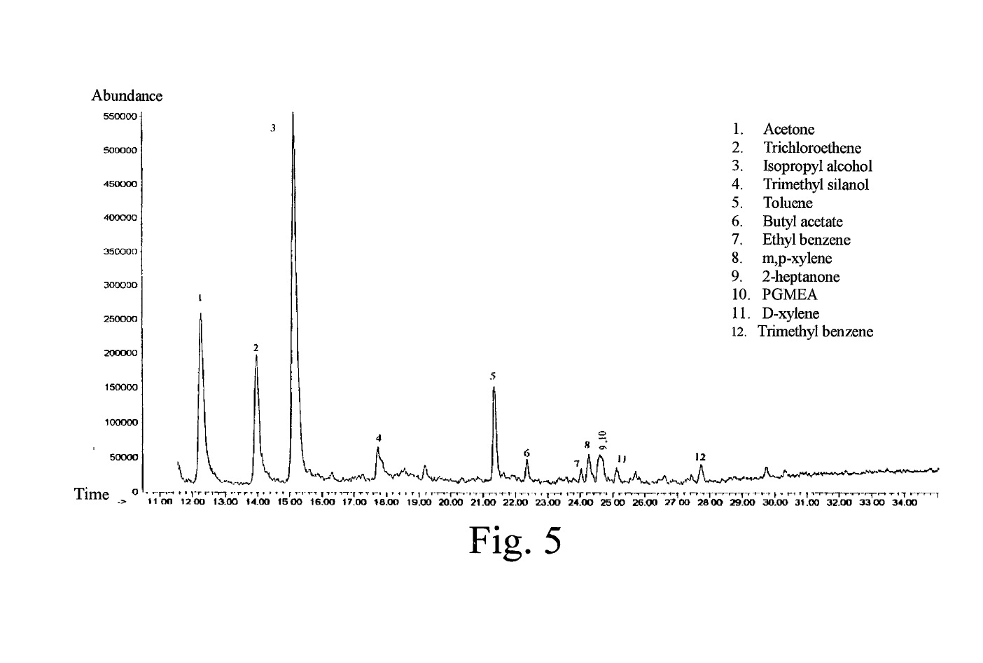

After sampling, the multi-sorbent traps adsorbing the volatile organic compound sample are immediately purged by clear nitrogen for 5 minutes. Sequentially, the multi-sorbent traps are analyzed by freezing concentration thermal desorption apparatus, gas chromatograph, and mass spectrophotometer. As shown in Table 9 and FIG. 5, the results indicate that 12 gaseous pollution compounds can be detected, wherein the amounts of 7 volatile organic compounds can be determined according to the present invention. Acetone and IPA have higher concentrations than other as shown in Table 9, the average values of concentrations are 117.9 ppbv and 182.3 ppbv, respectively.

Accordingly, the sampling apparatus according to the present invention has the following advantages:

1. The multi-sorbent trap according to the present invention can simultaneously adsorb polar and non-polar organic compounds for conveniently proceeding the follow-up qualitative and quantitative analysis, thereby reducing labor- and time-consumptions.

2. The sampling apparatus according to the present invention can collect the volatile organic compound at room temperature without the cooling equipment, so it has convenience and flexibility for application.

TABLE 9
The sampling apparatus of the present invention applied in a
semiconductor plant to determine the volatile organic compounds

| ¹ | | | | | | | |
|---|---|---|---|---|---|---|---|
| Peak | | | | | 12 | | |
| No. | 1 | 2 | 8 | 9 | 2- | 11 | 14 |
| | | | | Butyl | hepta- | m,p- | o- |
| Time | Acetone | IPA | Toluene | acetate | none | Xylene | Xylene |
| 10:15 | 116 | 416.9 | 40 | 19.6 | 65.3 | 18.7 | 17.9 |
| 11:15 | 53.1 | 171.9 | 19.3 | 13.5 | 107.2 | 16.5 | 12.9 |
| 12:15 | 40.4 | 172.7 | 20.7 | 10.4 | 67.5 | 17.5 | 18.5 |
| 13:15 | 796.1* | 904.3* | 14.3 | 13.2 | 91.0 | 19.2 | 13.6 |
| 14:15 | 434.6 | 751.6* | 13.3 | 12.2 | 138.4 | 16.5 | 14.8 |
| 15:15 | 203.3 | 1377.5* | 12.3 | 18.3 | 56.6 | 14.6 | 14.3 |
| 16:15 | 870.7* | 360.5 | 11.9 | 10.2 | 61.1 | 17.6 | 16.8 |
| 17:15 | 144 | 156 | 15.4 | 16.4 | 95.4 | 23.6 | 19.8 |
| 18:15 | 50 | 132 | 16.8 | 17.3 | 54.3 | 25.8 | 17.6 |
| 19:15 | 44.7 | 130.3 | 25.3 | 15.0 | 98.8 | 24.9 | 19.7 |
| 20:15 | 51 | 108.8 | 31.8 | 10.4 | 104.0 | 17.4 | 13.6 |
| 21:15 | 73 | 115.8 | 37.7 | 19.4 | 77.1 | 16.9 | 17.2 |
| 22:15 | 47.4 | 234.4 | 27.4 | 19.6 | 68.6 | 18.6 | 19.4 |
| 23:15 | 41.8 | 206.2 | 21.3 | 22.6 | 134.2 | 24.5 | 20.8 |
| 00:15 | 55.5 | 127 | 172.0 | 13.0 | 105.0 | 27.5 | 21.6 |
| 01:15 | 128.9 | 185.3 | 21 | 27.1 | 67.9 | 21.3 | 24.3 |
| 02:15 | 72.5 | 153.8 | 18.9 | 26.6 | 64.7 | 18.2 | 20.8 |
| 03:15 | 78.4 | 104.8 | 18.3 | 13.8 | 71.5 | 15.3 | 18.7 |
| 04:15 | 58.1 | 106.3 | 17.4 | 15.0 | 86.0 | 19.5 | 13.6 |
| 05:15 | 38.7 | 137 | 26 | 20.8 | 71.7 | 17.6 | 16.4 |
| 06:15 | 89.4 | 139.6 | 28.7 | 21.3 | 69.2 | 18.5 | 17.5 |
| 07:15 | 2970.1* | 311.3 | 37.1 | 19.7 | 70.7 | 17.6 | 15.6 |
| 08:15 | 439.2 | 174.7 | 27.8 | 14.4 | 78.5 | 19.6 | 12.9 |
| 09:15 | 216.1 | 680.2* | 24 | 16.9 | 61.0 | 17.4 | 13.4 |
| ² | 117.9 | 182.3 | 29.1 | 16.9 | 81.9 | 19.4 | 17.2 |
| AVG | | | | | | | |
| Max. | 439.2 | 416.9 | 172 | 27.1 | 138.4 | 27.5 | 24.3 |
| Min. | 38.7 | 104.8 | 11.9 | 10.2 | 54.3 | 14.6 | 12.9 |
| ³ | 117.7 | 86.5 | 31.5 | 4.7 | 22.9 | 3.4 | 3.1 |
| Sta.D | | | | | | | |

Unit: ppb
*The value is out of standard curve.
¹The peak numbers are corresponding to those shown in Fig. 4.
²AVG = average
³Sta D= Standard deviation

In sum, the sampling apparatus applied in the semiconductor operating environment according to the present invention indeed can solve the defects of prior art and practically can be applied in the aspect of industrial safety.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sampling apparatus applied in a semiconductor operating environment for collecting a volatile organic compound, comprising:
an automatic sampling device; and
a multi-sorbent trap connected to said automatic sampling device for adsorbing said volatile organic compound at room temperature, wherein said volatile organic compound comprises a polar and a non-polar compounds.

2. The sampling apparatus according to claim 1, wherein said volatile organic compound is one selected from a group consisting of acetone, isopropyl alcohol (IPA), benzene, trichloroethylene, toluene, butyl acetate, m,p-xylene, o-xylene, cyclopentanone, 2-heptanone and the mixture thereof.

3. The sampling apparatus according to claim 1, wherein said multi-sorbent trap is connected to a freezing concentration thermal desorption apparatus for desorbing said volatile organic compound.

4. The sampling apparatus according to claim 3, wherein said freezing concentration thermal desorption apparatus is connected to a gas chromatograph and a mass spectrophotometer for proceeding qualitative and quantitative analysis of said volatile organic compound.

5. The sampling apparatus according to claim 1, wherein said volatile organic compound has a minimum detecting concentration of ppbv.

6. The sampling apparatus according to claim 1, wherein multi-sorbent trap has an adsorbent comprises a graphitized carbon black and a carbon molecular sieve.

7. The sampling apparatus according to claim 6, wherein said graphitized carbon black has a specific area of 10˜100 cm²/g and said carbon molecular sieve has a specific area of 800˜850 cm²/g.

8. The sampling apparatus according to claim 1, wherein said multi-sorbent trap is a glass tube.

9. The sampling apparatus according to claim 1, wherein said automatic sampling device is a continuously automatic sampling device.

10. The sampling apparatus according to claim 9, wherein said continuously automatic sampling device is connected to 24 said multi-sorbent traps.

11. A sampling apparatus applied in a semiconductor operating environment for collecting a volatile organic compound, comprising:
an automatic sampling device connected to a multi-sorbent trap for adsorbing said volatile organic compound at room temperature, wherein said volatile organic compound comprises a polar and a non-polar compounds;
a freezing concentration thermal desorption apparatus connected to said multi-sorbent trap for desorbing said volatile organic compound; and
a gas chromatograph and a mass spectrophotometer connected to said freezing concentration thermal desorption apparatus for proceeding qualitative and quantitative analysis of said volatile organic compound.

12. The sampling apparatus according to claim 11, wherein said gas chromatograph is connected to said mass spectrophotometer in series.
